(19) United States
(12) Patent Application Publication
(10) Pub. No.: US 2013/0051824 A1
(43) Pub. Date: Feb. 28, 2013

(54) PREVENTING FUSER ROLLER DAMAGE BY THICK RECEIVERS

(71) Applicants: Robert David BOBO, Ontario, NY (US); Muhammed ASLAM, Rochester, NY (US); David Francis CAHILL, Rochester, NY (US)

(72) Inventors: Robert David BOBO, Ontario, NY (US); Muhammed ASLAM, Rochester, NY (US); David Francis CAHILL, Rochester, NY (US)

(21) Appl. No.: 13/214,495

(22) Filed: Aug. 22, 2011

(51) Int. Cl. G03G 15/00; G03G 15/20

(52) U.S. Cl. 399/45; 399/67; 399/122

(57) ABSTRACT

An electrophotographic method is disclosed that reduces damage to a fusing roller by taking into account the thickness of the receiver sheet and adjusting the spacing between the fusing rollers in accordance with such thickness to ensure that a toned image is fully fixed on a receiver sheet while reducing damage to the fusing rollers.

### CROSS-REFERENCE TO RELATED APPLICATIONS

Reference is made to commonly-assigned U.S. patent application Ser. No. 12/915,364 filed Oct. 29, 2010 (D96483), entitled “CONTROLLING SPEED TO REDUCE IMAGE QUALITY ARTIFACTS” to Dobbertin, et al., the disclosure of which is incorporated herein.

### FIELD OF THE INVENTION

This invention generally relates to electrostatographic devices and methods that use a heated fuser roller to permanently fix dry toner images to a receiver.

### BACKGROUND OF THE INVENTION

In a typical electrophotographic print engine that uses dry toner to print images on receiver sheets such as paper, the dry toner image is permanently fixed to a receiver sheet by subjecting the dry toner-bearing receiver sheet to include heat and pressure. This is generally accomplished by feeding the dry toner image bearing receiver sheet into a nip formed between a heated rotatable fuser roller and a second rotatable fuser roller. Then, subjecting the dry toner image to sufficient heat and pressure so as to raise the toner to a temperature above the glass transition temperature T_{g} of the toner while subjecting the dry toner to sufficient pressure to permit the individual toner particles to flow into a coherent mass and bond to the receiver. Typically, dry toner contains a polymer binder such as polyester or polystyrene. In addition, dry toner can contain other components such as charge control agents, waxes or semicrystalline materials such as polyethylene or polypropylene to facilitate release of the image-bearing receiver sheets from the fuser rollers, particulate addenda such as silica to control toner flow and adhesion. In many applications, the fuser rollers are coated with a thin layer of a release aid such as a silicone oil to facilitate release of the receiver sheet from the fuser rollers.

The surface (or the topcoat) for both rotatable fuser rollers requires ultra low surface energy to release the substrate. An effective topcoat material for oil-less fusing is high-temperature tolerant thermoplastic, such as FEP (polyfluorinated ethylene-propylene), PFA (perfluoroalkoxy-tetrafluoroethylene), or PTFE (polytetrafluoroethylene) as described in US Published Applications 20070298252, 20070298251, 20070298217, and 20070296122 each of which were published on Dec. 27, 2007.

It has been observed that receiver sheet lead and trail edges can also leave wear marks on the topcoat of the fuser roller surface, and that foreign materials from the receiver sheet can also periodically accumulate on that surface and can cause damage to the fuser roller and particularly its top coat.

### SUMMARY OF THE INVENTION

The present invention provides a method that reduces or limits damage to a fuser rollers used in a dry electrophotographic print engine when feeding receiver sheets.

The present invention provides an electrophotographic method for reducing damage to a fusing roller, comprising:

a) providing a fusing system having first and second rotatable fusing rollers that engage each other to form a fuser nip, the first roller having a surface that engages a toned receiver sheet having a top surface that engages and the second roller having a surface that engages the opposite surface of the receiver sheet;

b) using a sheet feeding transport member in the form of a moveable web to feed a toned receiver sheet into the fuser nip;

c) detecting the lead edge of the receiver sheet to produce a signal indicating the receiver sheet is about to enter the fuser nip;

d) determining the thickness of the receiver sheet that is a function of the relative spacing between the rotatable fusing rollers; and

e) moving the first or second rotatable fusing rollers or both from an unloaded or partially loaded state to a closed or fully loaded state in response to the signal and the thickness of the receiver sheet and then using the rotatable rollers forming the fuser nip to transport the receiver sheet through the fuser nip.

The present invention recognizes that the thickness of a receiver sheet is used to determine the fully loaded state of the fusing system. This feature reduces damage to the fusing rollers by taking into account the thickness of the receiver sheet.

### BRIEF DESCRIPTION OF THE DRAWINGS

FIG. 1 is a schematic of the fusing system including control electronics shown in block form that is used to practice the invention.

FIG. 2 is a schematic showing the fusing system as the receiver sheet enters the fuser nip.

FIG. 3 shows the first and second rotatable fuser rollers after the receiver sheet has entered the fuser nip.

### DETAILED DESCRIPTION OF THE INVENTION

Rotatable fusing rollers 100 and 105 are used in a fusing system in an electrophotographic print engine to permanently fix images made with dry toner 75 to a receiver sheet 140. Both of these rollers include a rigid cylindrical core 175 and an elastomeric blanket 180 coaxial with the core. A heating element 110 provides enough heat to raise the temperature of the dry toner 75 above its glass transition temperature to melt the dry toner 75 and fix it to the receiver sheet 140. A fuser drive controller 85 rotates the rotatable fusing rollers 100 and 105. Receiver sheet skiving devices 115 guide the receiver sheet 140 out of the fuser nip 170. To facilitate release of the fused image bearing receiver sheet 140 from the fusing system, the rotatable fusing rollers 100 and 105 are often coated with low surface energy, semicrystalline thermoplastic topcoat materials, such as FEP (polyfluorinated ethylene-propylene), PFA (perfluoroalkoxy-tetrafluoroethylene), or PTFE (polytetrafluoroethylene). Low surface energy refers to materials having a surface energy of less than 30 ergs/cm², preferably less than 25 ergs/cm², and more preferably less than 20 ergs/cm², as determined from the contact angle with a non-polar and a polar liquid such as distilled water and diiodomethane and using the Good-Girafalco approximation to approximate the interfacial energy. Other forms of low surface energy materials can also be used to overcoat the rollers. These include various elastomeric silicones as well as certain low surface energy ceramics such as fluorinated creamers.

The present invention is not dependent on how the rotatable fusing roller is manufactured, i.e., not affected by whether the topcoat is sleeve molded, sintered with dispersion, sprayed or transfer-coated. The method of the present invention will increase the usable life of the rotatable fusing roller owing to its ability to prevent surface irregularities by taking into account the thickness of the toned receiver sheet.

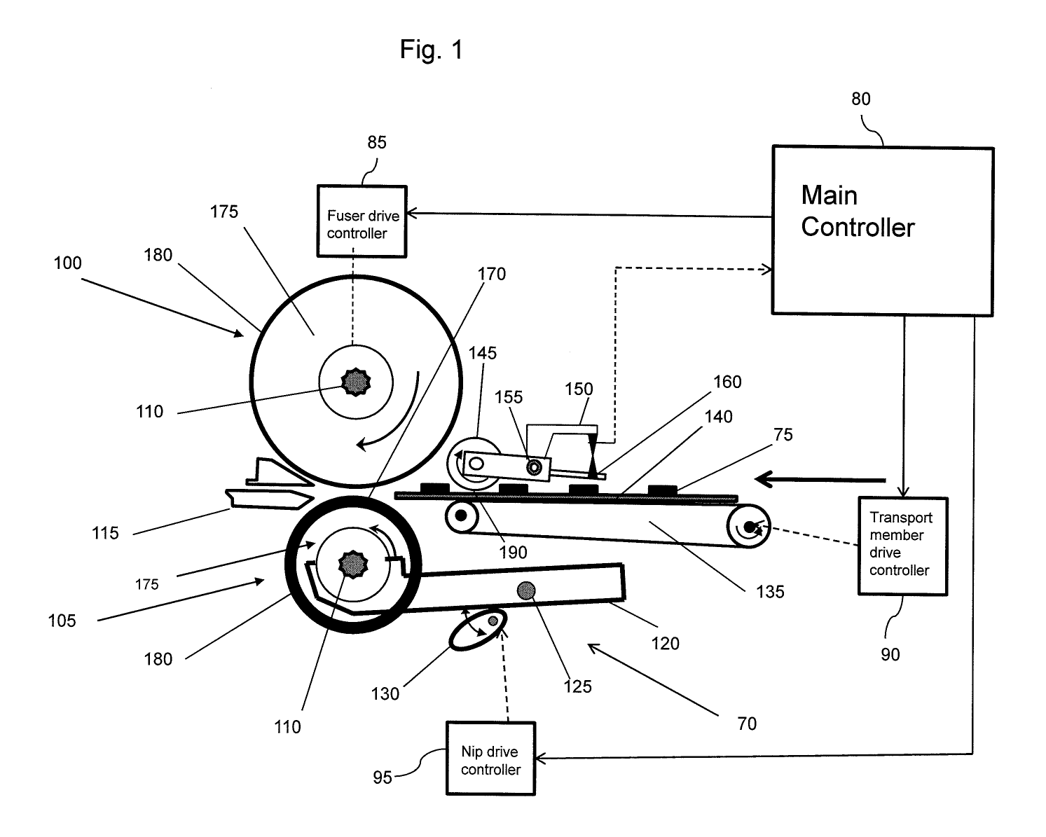

FIG. 1 shows a fusing system having a rotatable fusing member nip engagement mechanism 70. When a thick receiver sheet 140, i.e. a sheet having a thickness greater than 0.004 inches, preferably greater than 0.006 inches is about to enter the fuser nip 170, a main controller 80 causes a nip drive controller 95 to drive a cam 130 against a fusing nip member load arm 120 which is mounted about a rotatable fusing nip member load arm pivot point 125 to decrease pressure or unload the fuser nip 170 so as to permit the receiver sheet 140 to enter the fuser nip 170 without impacting the first and second rotatable fusing rollers 100 and 105. Once the receiver sheet 140 has entered the fuser nip 170, the main controller 80 causes the nip drive controller 95 to rotate the cam 130 against the fusing nip member load arm 120 to reapply pressure or to close the fuser nip 170 gap, preferably prior to a dry toner 75 portion of the receiver sheet 140 entering the fuser nip 170. Prior to the receiver sheet 140 exiting the fuser system, but preferably after the dry toner 75 areas of the receiver sheet 140 have exited the fuser nip 170, the main controller 80 can activate the nip drive controller 95 to rotate the cam 130 to move the fusing nip member load arm 120 to decrease the pressure or to increase the displacement between the rotatable fusing members 100 and 105 so that the two members do not impact each other upon the receiver sheet 140 exiting the fuser nip 170.

The main controller 80 sends a signal to the transport member drive controller 90 which actuates the sheet feeding transport member in the form of a moveable web 135 to feed the receiver sheet 140 into the fuser nip 170.

Methods of actuating the nip between the first rotatable fusing roller 100 and the second rotatable fusing roller 105 are not limited to the rotatable fusing member nip engagement mechanism 70 shown and can include other actuation devices such as air cylinders, electrical solenoids or a worm gear mechanism (not shown) to change the displacement between the first rotatable fusing roller 100 and the second rotatable fusing roller 105. The air cylinder would use pneumatic pressure to actuate. The solenoid would use electric current to actuate and the worm gear would actuate along a line.

One method of detecting the thickness of the receiver sheet 140 is shown. A receiver sheet thickness detector roller 145 is attached to a receiver sheet thickness detector mounting frame 150 and engaged with the sheet feeding transport member in the form of a moveable web 135 by a rotatable thickness detector pivot point 155. The receiver sheet thickness detector roller 145 position is sensed by a thickness detector transducer 160 such as a strain gage that measures the deflection of the receiver sheet thickness detector roller 145 from the sheet feeding transport member in the form of a moveable web 135. Upon entry into the thickness detector nip 190 formed between the receiver sheet thickness detector roller 145 and the sheet feeding transport member in the form of a moveable web 135 by the receiver sheet 140, the receiver sheet thickness determination roller 145 is deflected by the thickness of the receiver sheet 140. This deflection is registered by the thickness detector transducer 160 which feeds the deflection signal into the main controller 80 that controls the rotatable fusing member nip engagement mechanism 70. The rotatable fusing member nip engagement mechanism 70 then separates the first rotatable fusing roller 100 from the second rotatable fuser roller 105 by an amount at least as great as the thickness of the receiver sheet 140. The reengagement time for reengaging the first and second rotatable fusing rollers 100 and 105 is determined by the process speed of the electrophotographic apparatus and the distance between the contact point of the receiver sheet thickness detector roller 145 and the sheet feeding transport member in the form of a moveable web 135 and the fuser nip 170 between the first rotatable fusing roller 100 and second rotatable fusing roller 105. After disengaging for the period sufficient to permit the receiver lead edge of the receiver sheet 140 to enter the fuser nip 170, but preferably prior to the time needed for the dry toner 75 bearing portion of the receiver sheet 140 to enter the fusing nip 170, the main controller 80 reengages the first rotatable fusing roller 100 and second rotatable fuser roller 105.

The rotatable fusing member nip engagement mechanism 70 permits adjustable displacement between the first rotatable fusing roller 100 and the second rotatable fusing roller 105 can apply fully loaded pressure to the receiver sheet 140 while the receiver sheet 140 is in the fuser nip 170 to raise the dry toner 75 to a temperature above the glass transition temperature T_{g} of the dry toner 75 while subjecting the dry toner 75 to sufficient pressure to permit the individual dry toner particles 75 to flow into a coherent mass and bond to the receiver sheet 140 for the receiver sheet type and desired surface finish. During the time the receiver sheet 140 is not in the fuser nip 170, the rotatable fusing member nip engagement mechanism 70 can cause the displacement between the first rotatable fusing roller 100 and the second rotatable fusing roller 105 to be in an open or unloaded state where the distance between the first rotatable fusing roller 100 and the second rotatable fusing roller 105 is greater than the thickness of the receiver 140 or it can be in a partially loaded state where the displacement is less than the thickness of the receiver sheet 140. Thereafter, the distance between the fusing rollers is reduced and they are in a fully loaded state where they engage and fix the toned image to the receiver.

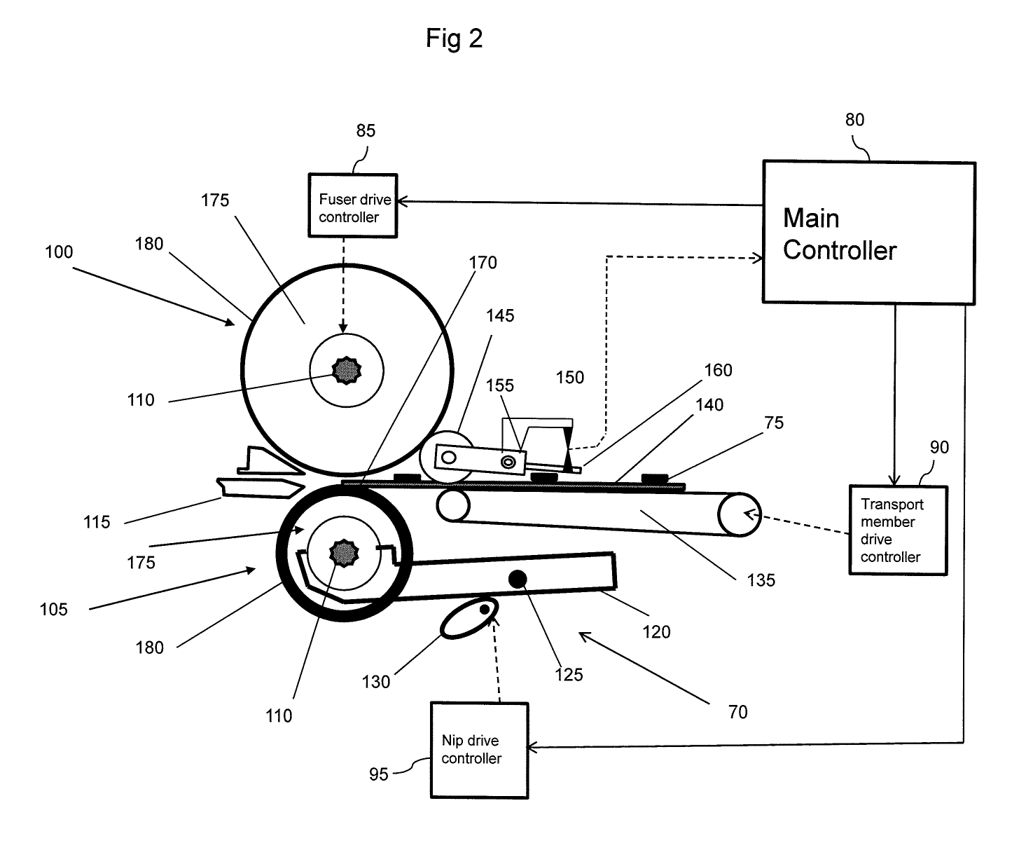

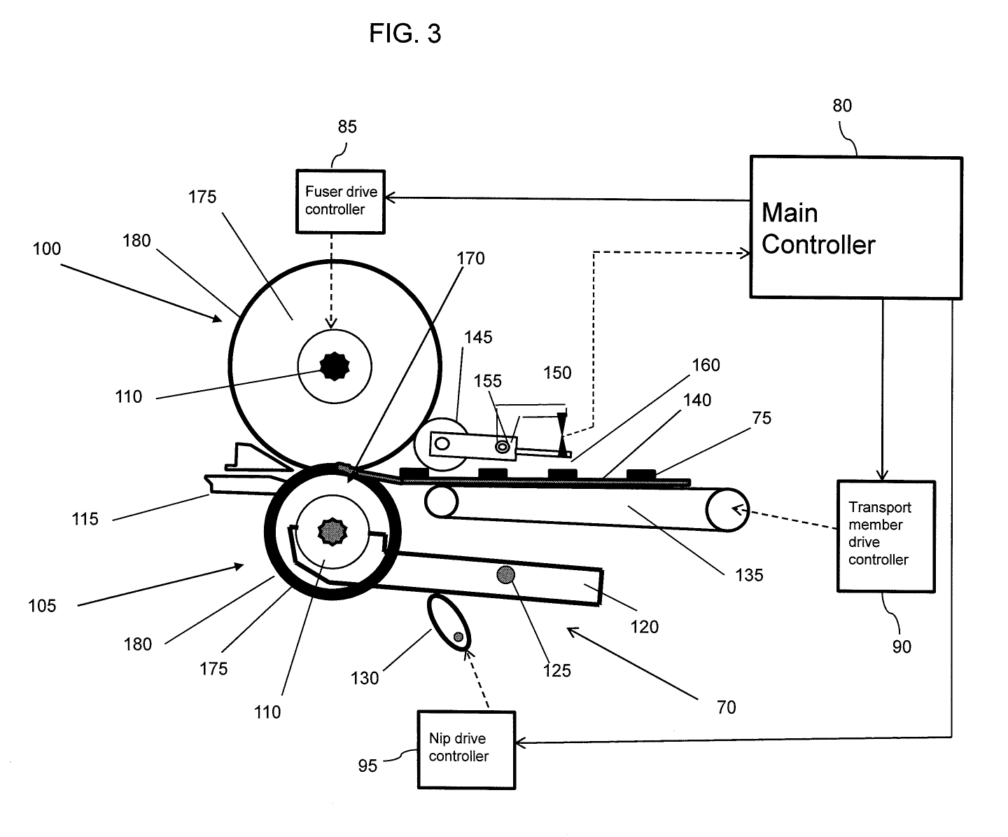

As shown in FIG. 1, the fusing rollers 100, 105 are in an open state and then they are moved to a partially loaded state which is shown in FIG. 2 under the control of the main controller 80. As shown in FIG. 3, the controller 80 causes the fusing rollers 100, 105 to move to the fully loaded state where the toned image is fixed to the receiver sheet 140.

Other ways (not shown) of determining the thickness of the receiver sheet 140 can also be employed. These include measuring the transit times of ultrasonic waves to the transport member in the form of a moveable web 135. This time is determined by the size of the gap between the ultrasonic transmitter/receiver assembly (not shown) and the surface against which the ultrasonic waves are reflected. The presence of a receiver sheet 140 will decrease this distance, thereby shortening the transit time of the ultrasonic wave.

In another method of practicing this invention, the characteristics of the receiver sheet 140 is entered into the main controller 80. This is done either using a bar code on the receiver sheet 140 or the packaging of the receiver sheets 140 that contains the appropriate information. Alternatively, the operator can input the thickness of the receiver sheet 140 directly into the main controller 80 in a well known manner. The main controller 80 then uses a look up table to determine the thickness of the receiver sheet 140.

In yet another embodiment of this invention, the impact force of the receiver sheet 140 entering the fuser nip 170 between the rotatable fusing rollers 100 and 105 is measured and the nip drive controller 95 can increase the separation or pressure until the impact force decreases to a sufficiently low level, preferably no impact force, indicating that sufficient separation has been achieved.

It will be understood that the receiver sheet 140 in FIG. 2 when entering the nip is in a partially loaded state. A fully loaded state means that the thickness of the receiver sheet 140 has been taken into consideration in adjusting the spacing between the fuser rollers 100, 105 so that the toned image on the receiver sheet 140 is fully fixed to the receiver sheet 140. The spacing, of course, is a function of the spacing of the receiver sheet 140 and will change as different receiver sheets are used. FIG. 2 shows a partially loaded state where when the lead edge of the receiver sheet 140 enters the fuser nip 170, it will be engaged by the surfaces of both the fusing rollers 100, 105, but it is not in a fully loaded state which is needed to ensure that the toned image will be fully fixed to the receiver sheet 140.

FIG. 2 shows the entrance of the receiver sheet 140 into the fuser nip 170 in the fusing assembly when practicing this invention. In this embodiment the rotatable fusing rollers 100 and 105 are separated, producing a displacement that is at least as large as the thickness of the receiver sheet 140.

FIG. 3 shows the reengagement of the rotatable fusing rollers 100, 105 once the edge of the receiver sheet 140 has entered the fusing nip 170, but prior to the entrance of the dry toner 75 portion of the receiver sheet 140 entering the fusing nip 170.

The invention has been described in detail with particular reference to certain preferred embodiments thereof, but it will be understood that variations and modifications can be effected within the spirit and scope of the invention

### PARTS LIST

75 Dry Toner
70 Rotatable fusing member nip engagement mechanism
80 Main Controller
85 Fuser drive controller (on figure, but don't see in description)
90 Transport member drive controller
95 Nip drive controller
100 First rotatable fusing roller
105 Second rotatable fusing roller
110 Heating element
115 Receiver sheet skiving device
120 fusing nip member load arm
125 Rotatable fusing nip member load arm pivot point
130 Cam
135 Sheet feeding transport member in the form of a moveable web
140 Receiver sheet
145 Receiver sheet thickness detector roller
150 Receiver sheet thickness detector mounting frame
155 Thickness detector pivot point
160 Thickness detector transducer
165 Toned receiver sheet top surface
170 Fuser nip
175 Rigid cylindrical core
180 Elastomeric blanket
190 Thickness detector nip

1. An electrophotographic method for reducing damage to a fusing roller, comprising:
a) providing a fusing system having first and second rotatable fusing rollers that engage each other to form a fuser nip, the first roller having a surface that engages a toned receiver sheet having a top surface that engages and the second roller having a surface that engages the opposite surface of the receiver sheet;
b) using a sheet feeding transport member in the form of a moveable web to feed a toned receiver sheet into the fuser nip;
c) detecting the lead edge of the receiver sheet to produce a signal indicating the receiver sheet is about to enter the fuser nip;
d) determining the thickness of the receiver sheet that is a function of the relative spacing between the rotatable fusing rollers; and
e) moving the first or second rotatable fusing rollers or both from an unloaded or partially loaded state to a closed or fully loaded state in response to the signal and the thickness of the receiver sheet and then using the rotatable rollers forming the fuser nip to transport the receiver sheet through the fuser nip.

2. The method according to claim 1 further including a low surface energy, semicrystalline thermoplastic topcoat material, such as FEP (polyfluorinated ethylene-propylene), PFA (perfluoroalkoxy-tetrafluoroethylene), or PTFE (polytetrafluoroethylene in the top surface of the first rotatable fusing roller.

3. The method according to claim 2 further including a low surface energy, semicrystalline thermoplastic topcoat materials, such as FEP (polyfluorinated ethylene-propylene), PFA (perfluoroalkoxy-tetrafluoroethylene), or PTFE (polytetrafluoroethylene) in the top surface of the second rotatable fusing roller.

4. The method according to claim 1 wherein the sheet thickness determination is provided by a strain gage.

5. The method according to claim 1 wherein the receiver sheet thickness is predetermined and stored in a controller.

6. The method according to claim 1 wherein the receiver sheet thickness is determined by using an ultrasonic technique.

7. The method according to claim 1 wherein the receiver sheet thickness is determined by the impact force of the receiver sheet entering the fuser nip.

8. The method according to claim 1 moving the first rotatable fusing roller by using a cam.

9. The method according to claim 1 wherein moving the first rotatable fusing roller is accomplished by using an air cylinder.

10. The method according to claim 1 wherein moving the first rotatable fusing roller is accomplished by using a worm gear.

11. The method according to claim 1 wherein moving the first rotatable fusing roller is accomplished by using an electrical solenoid responsive to an electrical signal produced by a controller.

12. An electrophotographic method for reducing damage to a fusing roller, comprising:
a) providing a fusing system having first and second rotatable fusing rollers that engage each other to form a fuser nip, the first roller having a surface that engages a toned receiver sheet having a top surface that engages and the second roller having a surface that engages the opposite surface of the receiver sheet;
b) using a sheet feeding transport member in the form of a moveable web to feed a toned receiver sheet into the fuser nip;
c) detecting the lead edge of the receiver sheet to produce a signal indicating the receiver sheet is about to enter the fuser nip;
d) determining the thickness of the receiver sheet that is a function of the relative spacing between the rotatable fusing rollers; and
e) moving the first or second rotatable fusing rollers or both from an unloaded state to a partially loaded state in engagement with the receiver sheet and then to a closed or fully loaded state in response to the signal and the thickness of the receiver sheet and then using the rotatable rollers forming the fuser nip to transport the receiver sheet through the fuser nip.
